(19) United States
(12) Patent Application Publication
(10) Pub. No.: US 2025/0276650 A1
(43) Pub. Date: Sep. 4, 2025

(54) SEATBACK STRAPS AND ACCESSORY ATTACHMENT

(71) Applicant: Rivian IP Holdings, LLC, Irvine, CA (US)

(72) Inventors: Alexander DeCastro Calachan, Costa Mesa, CA (US); Sean Edward Hadley, Capistrano Beach, CA (US); Matthew Mark Zoller, Marina Del Rey, CA (US)

(73) Assignee: Rivian IP Holdings, LLC, Irvine, CA (US)

(21) Appl. No.: 19/064,912

(22) Filed: Feb. 27, 2025

Related U.S. Application Data
(60) Provisional application No. 63/560,502, filed on Mar. 1, 2024.

(51) Int. Cl. B60R 7/04; B60N 2/56; B60R 11/00; B60R 16/033

(52) U.S. Cl. CPC B60R 7/043; B60N 2/56; B60R 16/033; B60R 11/00; B60R 2011/0015; B60R 2011/005; B60R 2011/0071

(57) ABSTRACT

An apparatus can include a strap assembly. The strap assembly can couple with a seatback of a vehicle. The strap assembly can include a strap. The strap can couple an object with the seatback of the vehicle.

### CROSS-REFERENCE TO RELATED PATENT APPLICATIONS

This application claims the benefit of and priority to U.S. Provisional Patent Application No. 63/560,502, filed Mar. 1, 2024, the entirety of which is incorporated by reference herein.

### INTRODUCTION

Vehicles can include seats to carry passengers.

### SUMMARY

This disclosure is generally related to one or more components of a vehicle. The components can include at least one apparatus. The apparatus can include at least one strap assembly. The strap assembly can couple with the vehicle. For example, the strap assembly can couple with a seatback of the vehicle. The strap assembly can include at least one strap. The strap can couple at least one object with the vehicle. For example, the strap can couple a backpack with the seatback of the vehicle.

At least one aspect is directed to an apparatus. The apparatus can include a strap assembly. The strap assembly can couple with a seatback of a vehicle. The strap assembly can include a strap. The strap can couple an object with the seatback of the vehicle.

At least one aspect is directed to a method. The method can include coupling a strap assembly with a seatback of a vehicle. The strap assembly can include a strap configured to couple an object with the seatback of the vehicle.

At least one aspect is directed to a vehicle. The vehicle can include a seat. The seat can have a seatback. The vehicle can include an apparatus. The apparatus can include a strap assembly. The strap assembly can couple with the seatback. The strap assembly can include a strap. The strap can couple an object with the seatback of the vehicle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts a perspective view of a seat including a strap assembly, in accordance with an implementation.

FIG. 3 depicts a perspective view of a seat including a strap assembly, in accordance with an implementation.

FIG. 4 depicts a perspective view of a seat including a strap assembly, in accordance with an implementation.

FIG. 5 depicts a perspective view of a seat including a strap assembly, in accordance with an implementation.

FIG. 6 depicts a process of coupling a strap assembly with a seatback of a vehicle, in accordance with an implementation.

### DETAILED DESCRIPTION

Following below are more detailed descriptions of various concepts related to, and implementations of, methods, apparatuses, and systems of seatback straps to secure objects to a vehicle. The various concepts introduced above and discussed in greater detail below may be implemented in any of numerous ways.

The present disclosure is directed to systems and methods of one or more components for a vehicle. The components can include a strap assembly. The strap assembly can couple with the vehicle. For example, the strap assembly can couple with a seatback of the vehicle. As another example, the strap assembly can couple with a housing of an apparatus and the housing can be coupled with the vehicle. The strap assembly can include at least one strap. The strap can couple an object with the vehicle. For example, the strap can couple a backpack, tote, first-aid kit, or other component with the seatback of the vehicle. As another example, the strap can secure a bag to the seatback of the vehicle.

The strap assembly or one or more components thereof can be disposed within the housing. For example, at least a portion of the strap can be disposed within the housing. The strap can retract into the housing. For example, at least a portion of the strap can move from outside the housing to inside the housing. The strap can also extend from within (e.g., inside) the housing to outside of the housing.

Storage within cabs of vehicles can be limited to a center console or storage compartment. The limited storage can cause objects to simply be placed within the cab. This can cause the objects to move while the vehicle is travelling due to the objects not being secured. Moreover, the storage components of the vehicle can be size restrictive regarding the objects that can be stored within.

The disclosed solutions have a technical advantage of providing a strap assembly that can couple objects, such as backpacks, pouches, bags, blankets, towels, speakers, or electronic devices to the seatback of a vehicle. The coupling of the objects, with the seatback of the vehicle can increase storage capacity within a cab of the vehicle while also removing objects from a surface within the cab of the vehicle. The disclosed solutions also include the strap assembly providing structural support to the seatback of the vehicle. For example, the strap assembly can provide structural support while coupling a backpack with the seatback of the vehicle.

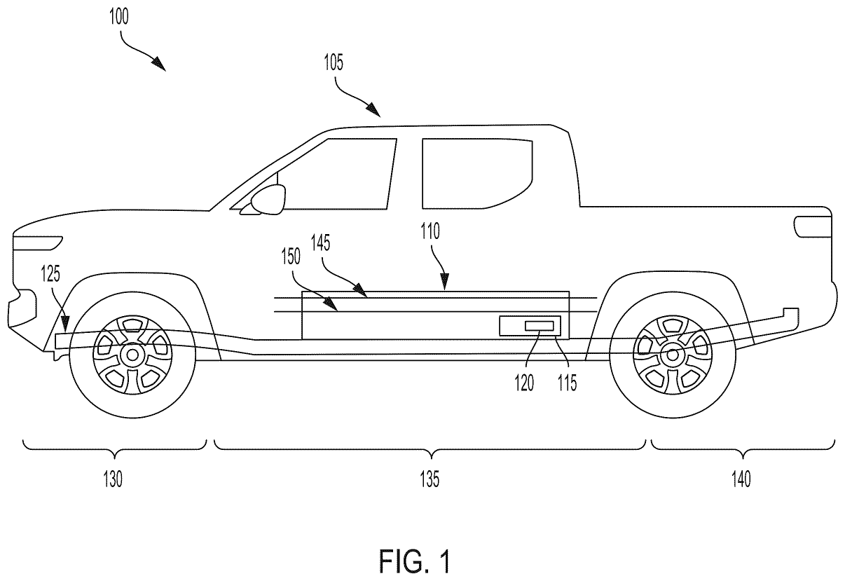

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the batteries 115, the battery modules 115, or the battery cells 120 with other electrical components of the electric vehicle 105 to provide electrical power to various systems or components of the electric vehicle 105.

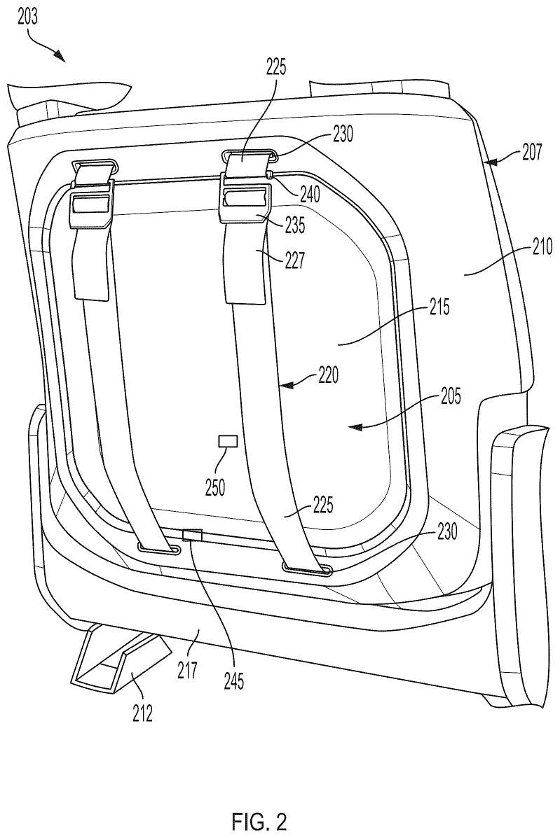

FIG. 2 is a perspective view of a seat 203. The seat 203 can be included with the vehicle 105. For example, the seat 203 can be a passenger seat of the vehicle 105. As another example, the seat 203 can be a driver seat of the vehicle 105. The seat 203 can include at least one component. For example, the seat 203 can include a seatback 207. The seatback 207 can refer to or include a backrest. The seatback 207 can also include or house components such as Heating, Ventilation, and Air Conditioning (HVAC) equipment, electrical connections, or other hardware. The seat 203 can also include at least one portion. For example, the seat 203 can include a hard portion and a cushion portion. The seat 203 can also include at least one mounting bracket 212 and at least one base 217. The mounting bracket 212 can couple, via at least one fastener, the seat 203 to the vehicle 105. For example, the mounting bracket 212 can couple the seat 203 with a floor of the vehicle 105. The base 217 can be coupled with the mounting bracket 212. For example, the base 217 can be secured to the mounting bracket 212. The base 217 can also be coupled with the seatback 207.

The seat 203 or one or more components thereof can have various dimensions. For example, the seat 203 can include a vertical height having a range of 30 to 40 inches. As another example, the seat 203 can include a vertical height having a range of 20-36 inches. The seatback 207 can have various dimensions. For example, the seatback 207 can have a width having a range of 24-40 inches. As another example, the seatback 207 can have a width having a range of 18-30 inches. The seat 203 or the one or more components thereof can be removably coupled with one another, such that a first component of the seat 203 can be removed (e.g., decoupled) from a second component of the seat 203. The seat 203 can include various material. For example, the seat 203 can include leather or cloth material.

The vehicle 105 can include at least one apparatus 205. The apparatus 205 can include the apparatus described herein. The apparatus 205 can be provided with the vehicle 105. For example, the apparatus 205 can be integrated with the vehicle 105. The apparatus 205 can be provided separate from the vehicle 105. For example, the apparatus 205 can be provided as a separate component. The apparatus 205 can include at least one strap assembly 220. The strap assembly 220 can include the strap assembly described herein.

The strap assembly 220 can couple with the vehicle 105. For example, the strap assembly 220 can couple with the seatback 207. The strap assembly 220 can couple with the seatback 207 by at least one of mounting, securing, attaching, or otherwise connecting the strap assembly 220 with the seatback 207. The strap assembly 220 can include at least one strap 225. The strap 225 can include rope, elastic bands, flexible material, a belt, a fastener, or other possible material to secure objects. The strap 225 can couple at least one object with the vehicle 105. For example, the strap 225 can couple a backpack with the vehicle 105. The strap 225 can couple the object with the vehicle 105 by at least one of securing, mounting, attaching, or otherwise connecting the object with the vehicle 105. For example, the strap 225 can secure a backpack (e.g., an object) with the seatback 207.

The apparatus 205 can include at least one housing 210. The housing 210 can define or create a structure or shape of the apparatus 205. The housing 210 can be integrated with the seatback 207. For example, the seatback 207 can include the housing 210. The housing 210 can be separate from the seatback 207. For example, the housing 210 can removably couple with the seatback 207 (e.g., the housing 210 can be removed from the housing 210). The housing 210 can couple with the seatback 207. For example, the housing 210 can be attached to the seatback 207. The seatback 207 can include at least one opening 230. For example, the seatback 207 can include a first opening 230 and a second opening 230. The openings 230 can include apertures or voids that provide space for objects to escape the seatback 207 or the housing 210. The strap assembly 220 can couple with the housing 210. For example, the strap assembly 220 can be attached to the housing 210. The housing 210 can include hard plastic or other rigid material.

The openings 230 can provide or create an area for a segment of the strap 225 or the strap assembly 220 to be inserted into the housing 210. For example, a segment 227 of the strap 225 can be inserted into the first opening 230 and then escape from the second opening 230. As another example, the strap 225 can include a first segment 227 and a second segment 227. To continue this example, the first segment 227 can escape the housing 210 via the first opening 230 and the second segment 227 can escape the housing 210 via the second opening 230. At least a portion of the strap 225 can be disposed within the housing 210. For example, at least a portion or segment of the strap 225 can be located within the housing 210.

The apparatus 205 can include at least one member 235. The member 235 can include at least one slip-lock. The member 235 can also include a strap holder. The member 235 can include plastic material. The member 235 can also include rubber or soft material. The member 235 can couple with one or more segments of the strap 225. For example, the member 235 can couple with a first segment 227 and a second segment 227. The member 235 can also couple the first segment 227 with the second segment 227. The first segment 227 can move, via the member 235, relative to the second segment 227. For example, the first segment 227 can move relative to the second segment 227 to couple an object with the seatback 207. As another example, the first segment 227 can lengthen, extend, or otherwise move to adjust a tension of the strap 225. For example, the first segment 227 can extend, away from the member 235, to increase a tension of the strap 225. To continue this example, pulling (e.g., extending) the first segment 227, in a given direction, can increase the tension of the strap 225. The member 235 can include at least one protrusion 240. The protrusion 240 can include an elongated member. The protrusion 240 can also include at least one extension. The protrusion 240 can insert into an opening of the strap 225 to couple a given segment 227 of the strap 225. For example, the protrusion 240 can insert into the second segment 227 to couple with the strap 225.

The seatback 207 can define at least one recess 215. For example, the seatback 207 can define an indent or void within the housing 210. The recess 215 can receive at least a portion of an object. For example, the recess 215 can receive at least a portion of a backpack. The housing 210 can couple with the seatback 207. For example, the housing 210 can be attached to the seatback 207. As another example, the housing 210 can be provided with the seatback 207. The housing 210 can provide structural support to the seatback 207. For example, the housing 210 can provide structural support to the seatback 207 with an object coupled with the seatback 207 via the strap 225. The recess 215 can shaped or designed to accommodate objects with various shapes or sizes.

The apparatus 205 can include at least one mechanism 245. The mechanism 245 can include at least one of a hinge, a latch, a pivot, or a swivel. For example, the mechanism 245 can pivot or otherwise move to adjust a position of an object. The mechanism 245 can be coupled with the seatback 207. For example, the mechanism 245 can be attached to the seatback 207. As another example, the mechanism 245 can be attached to the housing 210. The mechanism 245 can adjust a position of the object. For example, the mechanism 245 can couple with the object, with the object inserted into the recess 215. To continue this example, the mechanism 245 can pivot (e.g., adjust) a position of the object relative to the recess 215.

The seatback 207 can include at least one slot 250. The slot 250 can include an opening or a gap. The slot 250 can also include electrical hardware such as ports, outlets, receptacles, or access points. The housing 210 can also include the slot 250. The slot 250 can couple the object with one or more components of the vehicle 105. For example, the slot 250 can couple the object with an HVAC system of the vehicle. To continue this example, the object can receive, from the HVAC system, air to cool or air to heat the object. As another example, the object can be a cooler and the cooler can receive cooled air from the HVAC system via the slot 250. As another example, the slot 250 can couple the object with an energy storage device of the vehicle 105 (e.g., the batteries 115). To continue this example, the object can receive power from the energy storage device. Stated otherwise, the object can be powered via the batteries 115.

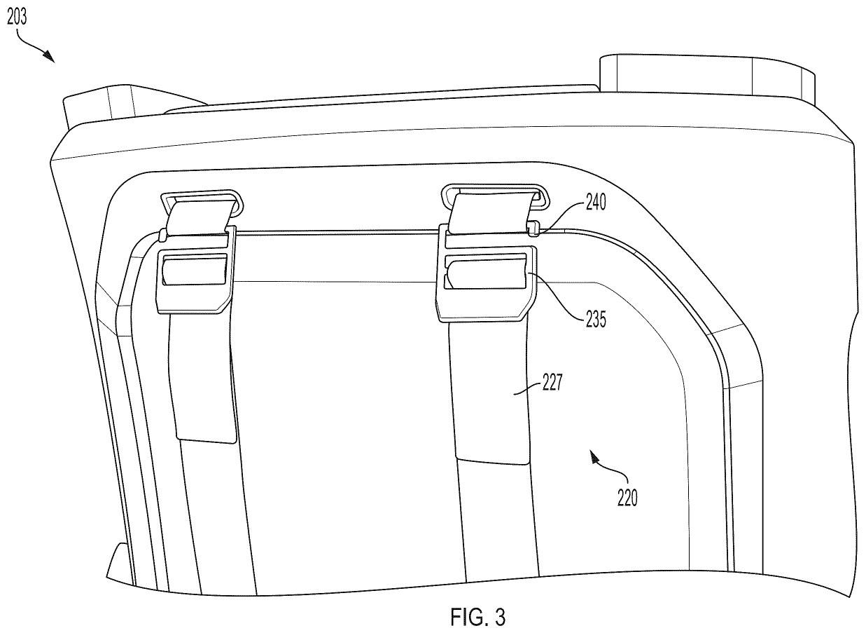

FIGS. 3-5 are perspective views of the seat 203. As shown in FIG. 3, the protrusion 240 can include a lip or a tab that is positioned external to and lateral to the strap 225. Stated otherwise, the protrusion 240 can have a lip that is situated towards the outside of the strap 225. While not shown in FIG. 3, the apparatus 205 can include at least one of webbing, netting, or lattice to hold one or more objects. For example, the apparatus 205 can include a tensile net that can hold objects. The tensile net can be positioned or located between the housing 210 and the strap 225. For example, the tensile net can be compressed, by the object, with the object secured by the strap 225. As another example, the tensile net can be accessible with the object decoupled from the strap 225.

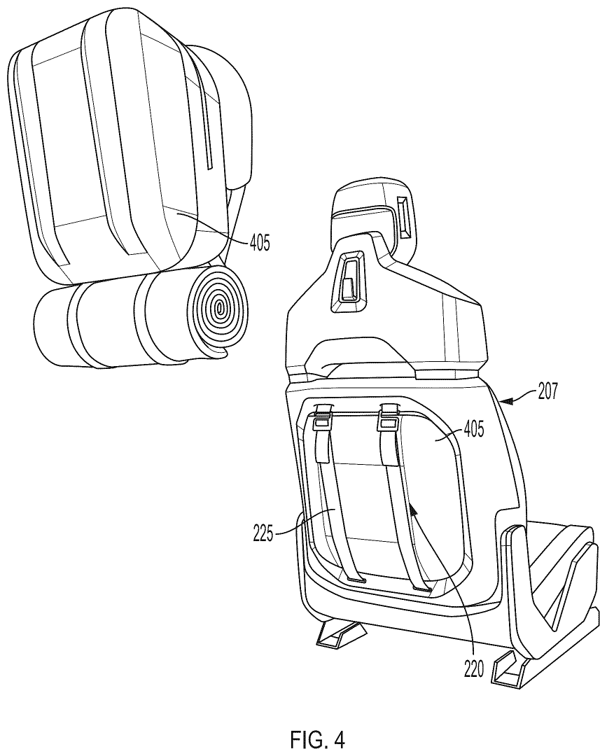

As shown in FIG. 4, an object 405 (shown as a backpack) can be positioned or housed within the seatback 207 via the housing 210. The strap 225 can secure the object 405 to the seatback 207 by applying tension to the object 405. The object 405 can couple with an HVAC system or an energy storage device via the slot 250. As illustrated in FIG. 4, the object 405 can include indents or notches that align with a position of the strap 225. For example, the strap 225 can rest or align with the notches of the object 405 with the object resting in the recess 215.

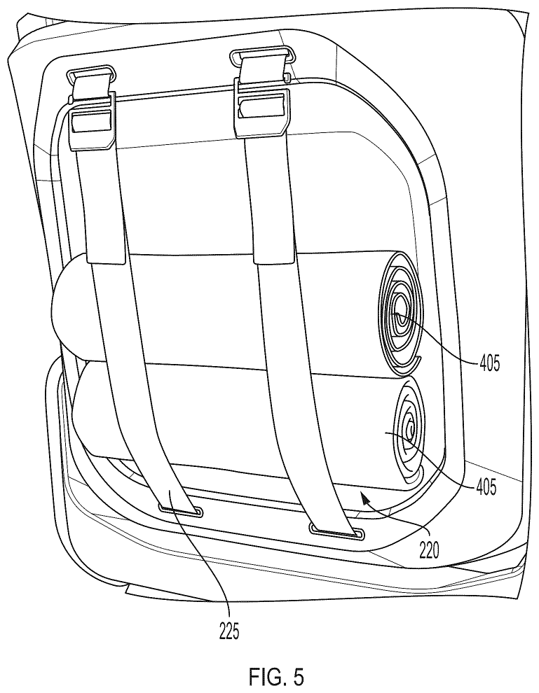

As shown in FIG. 5, the object 405 (shown as towels) can be secured to the seatback 207 via the strap 225. The strap 225 can secure the objects 405 by increasing, via the member 235, a tension on the strap 225. The strap 225 can release the objects 405 by reducing or decreasing a tension on the strap 225.

While some of the figures have illustrated the strap 225 in a vertical configuration (e.g., top-down arrangement), the strap 225 can include multiple configurations. For example, the strap 225 can include a horizontal configuration (e.g., a left-right arrangement) or a crisscross configuration (e.g., an x arrangement).

The object 405 can be adjustable or otherwise modifiable such that a dimension or size of the object 405 can change. For example, the object 405 can collapse, from an arrangement shown in FIG. 4, into a reduced form factor. Stated otherwise, the object 405 can collapse to reduce an overall size of the object 405. The object 405 can include one or more removable sections or segments such that an overall body or area of the object 405 can change.

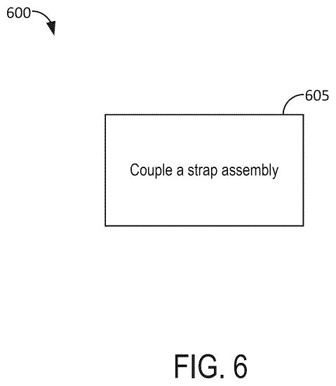

FIG. 6 depicts a flow diagram of a process 600 for manufacturing an apparatus. The apparatus can include the apparatus 205. The apparatus 205 can include the strap assembly 220. The manufacturing of the apparatus 205 can include providing the apparatus 205. For example, the apparatus 205 can be provided during assembly of the vehicle 105. The apparatus 205 can be provided responsive to the apparatus 205 having been purchased.

At step 605, a strap assembly can be coupled with a seatback of a vehicle. For example, the strap assembly 220 can be coupled with the seatback 207. The strap assembly 220 can be coupled with the seatback 207 by at least one of mounting, securing, attaching, or otherwise connecting the strap assembly 220 with the seatback 207. The strap assembly 220 can include the strap 225. The strap 225 can couple an object with the seatback 207. For example, the strap 225 can couple the object 405 with the seatback 207.

One or more segments (e.g., the segments 227) can move relative to or independent to one another such that a length or amount of a pull portion of the strap 225 is adjustable such that the pull portion can be lengthened or shortened depending upon which direction the pull portion is moved. Stated otherwise, the strap 225 can be tightened responsive to a lengthening of the pull portion and the strap 225 can be loosened responsive to a shortening of the pull portion.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a strap assembly configured to couple with a seatback of a vehicle; and
the strap assembly, comprising:
a strap configured to couple an object with the seatback of the vehicle.

2. The apparatus of claim 1, comprising:
at least a portion of the strap configured to dispose within a housing of the seatback of the vehicle;
the seatback of the vehicle comprising a first opening and a second opening; and
the strap, comprising:
a first segment configured to escape the housing via the first opening; and
a second segment configured to escape the housing via the second opening.

3. The apparatus of claim 1, comprising:
a member configured to couple with (i) a first segment of the strap and (ii) a second segment of the strap; and
the first segment of the strap configured to move, via the member, relative to the second segment of the strap, to couple the object with the seatback of the vehicle.

4. The apparatus of claim 1, comprising:
the seatback of the vehicle configured to define a recess; and
the recess configured to receive at least a portion of the object.

5. The apparatus of claim 1, comprising:
a housing configured to couple with the seatback of the vehicle; and
the housing configured to provide structural support to the seatback of the vehicle with the object coupled with the seatback of the vehicle via the strap.

6. The apparatus of claim 1, comprising:
a mechanism configured to couple with the seatback of the vehicle; and
the mechanism configured to adjust a position of the object.

7. The apparatus of claim 1, comprising:
a housing integrated with the seatback of the vehicle;
the strap assembly configured to couple with the housing.

8. The apparatus of claim 1, comprising:
a housing configured to couple with the seatback of the vehicle; and
the housing separate from the seatback of the vehicle.

9. The apparatus of claim 1, comprising:
the seatback of the vehicle comprising a slot to couple the object with a Heating, Ventilation, and Air Conditioning (HVAC) system of the vehicle; and
the object configured to receive, from the HVAC system, air to cool or air to heat the object.

10. The apparatus of claim 1, comprising:
the seatback of the vehicle comprising a slot to couple the object with an energy storage device of the vehicle; and
the object configured to receive power from the energy storage device.

11. A vehicle, comprising:
a seat having a seatback; and
an apparatus, including:
a strap assembly configured to couple with the seatback; and
the strap assembly, comprising:
a strap configured to couple an object with the seatback.

12. The vehicle of claim 11, the apparatus further comprising:
at least a portion of the strap configured to dispose within a housing of the seatback;
the seatback comprising a first opening and a second opening; and
the strap comprising:
a first segment configured to escape the housing via the first opening; and
a second segment configured to escape the housing via the second opening.

13. The vehicle of claim 11, the apparatus further comprising:
a member configured to couple with (i) a first segment of the strap and (ii) a second segment of the strap; and
the first segment of the strap configured to move, via the member, relative to the second segment of the strap, to couple the object with the seatback.

14. The vehicle of claim 11, the apparatus further comprising:
the seatback configured to define a recess; and
the recess configured to receive at least a portion of the object.

15. The vehicle of claim 11, the apparatus further comprising:
a housing configured to couple with the seatback; and
the housing configured to provide structural support to the seatback with the object coupled with the seatback via the strap.

16. The vehicle of claim 11, the apparatus further comprising:
a mechanism configured to couple with the seatback; and
the mechanism configured to adjust a position of the object.

17. The vehicle of claim 11, the apparatus further comprising:
a housing integrated with the seatback;
the strap assembly configured to couple with the housing.

18. The vehicle of claim 11, the apparatus further comprising:
a housing configured to couple with the seatback; and
the housing separate from the seatback.

19. A method, comprising:
coupling a strap assembly with a seatback of a vehicle; and
the strap assembly including a strap configured to couple an object with the seatback of the vehicle.

20. The method of claim 19, comprising:
disposing at least a portion of the strap within a housing of the seatback of the vehicle.
